(19) United States
(12) Patent Application Publication
(10) Pub. No.: US 2005/0240927 A1
(43) Pub. Date: Oct. 27, 2005

(54) On-demand tasks

(75) Inventor: Gregory Richard Hintermeister, Rochester, MN (US)

Correspondence Address: Grant A. Johnson;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/821,147

(22) Filed: Apr. 8, 2004

(51) Int. Cl. G06F 9/46

(52) U.S. Cl. 718/100

(57) ABSTRACT

A method, apparatus, system, and signal-bearing medium that in an embodiment determine a problem from a context, find an on-demand task associated with the problem, and present a notification of the availability of the on-demand task. If a use of the on-demand task is available, the context is passed to the on-demand task. In this way, on-demand tasks may be delivered to users.

### FIELD

An embodiment of the invention generally relates to computers. More particularly, an embodiment of the invention relates to providing tasks on demand for computers.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

As computers have become more complicated, managing the functions and resources of the computers has become more difficult. Some computers have software known as an administration console, which helps to monitor, manage, and control the computer. Often, the administration console is shipped as a standard feature of the computer. Although the administration console might be sufficient to perform basic functions, additional functions may be desirable in order to more easily monitor and control the computer. These additional functions must be purchased and installed on the computer in order to be used.

Unfortunately, determining the additional functions that might be helpful, purchasing, and installing them can be difficult for the following reasons. First, some customers lack the money, time, and training to obtain the functions. Thus, they never have an opportunity to experience the extra value that the functions might provide, so they never perceive that the functions might be worth the effort to obtain. Second, the standard functions of the console may not integrate seamlessly with the additional functions. Thus, to use the additional functions may require extra education, training, and testing. Third, often customers are not allowed to merely purchase the specific additional functions in which they are interested; instead, they must purchase an entire suite of functions in order to get the ones they want. Finally, when a customer experiences a problem with the computer for which an additional function might be helpful, the customer often must address the problem immediately and has no time to investigate a potentially helpful additional function, install it, and learn how to use it.

Some makers of additional functions have provided demonstration versions of their products and try-and-buy CDs (compact disks) in order to advertise their products. Unfortunately, these techniques require customers to install the product and register for a demonstration version that performs limited functions. In addition, the demonstration version may not integrate seamlessly with the customer's current functions.

Without a better way to handle integrating additional functions into a computer, customers will be unable to take full advantage of additional functions that might help them. Although the aforementioned problems have been described in the context of administration consoles, they can occur in any environment where additional functions may be available.

### SUMMARY

A method, apparatus, system, and signal-bearing medium are provided that in an embodiment determine a problem from a context, find an on-demand task associated with the problem, and present a notification of the availability of the on-demand task. If a use of the on-demand task is available, the context is passed to the on-demand task. In this way, on-demand tasks may be delivered to users.

### BRIEF DESCRIPTION OF THE DRAWINGS

FIG. 1 depicts a block diagram of an example system for implementing an embodiment of the invention.

FIG. 2 depicts a pictorial representation of an example user interface that includes a problem, according to an embodiment of the invention.

FIG. 3 depicts a pictorial representation of an example user interface for an on-demand task for addressing the problem, according to an embodiment of the invention.

FIG. 4 depicts a pictorial representation of an example user interface for a view hardware task, according to an embodiment of the invention.

FIG. 5 depicts a pictorial representation of an example user interface for a hardware zone on-demand task, according to an embodiment of the invention.

FIG. 6A depicts a block diagram of an example data structure for an on-demand task list, according to an embodiment of the invention.

FIG. 6B depicts a block diagram of an example data structure for an authorization list, according to an embodiment of the invention.

FIG. 7 depicts a flowchart of example processing for an on-demand controller, according to an embodiment of the invention.

### DETAILED DESCRIPTION

An embodiment of the invention determines a problem from a context, finds an on-demand task associated with the problem, and presents a notification of the availability of the on-demand task. The problem may be a condition or a function. The on-demand task may be helpful in addressing the condition or may be a more helpful alternative to the function. If a use of the on-demand task is available, the context is passed to the on-demand task, which uses the context to perform its functions. In this way, on-demand tasks may be delivered to users.

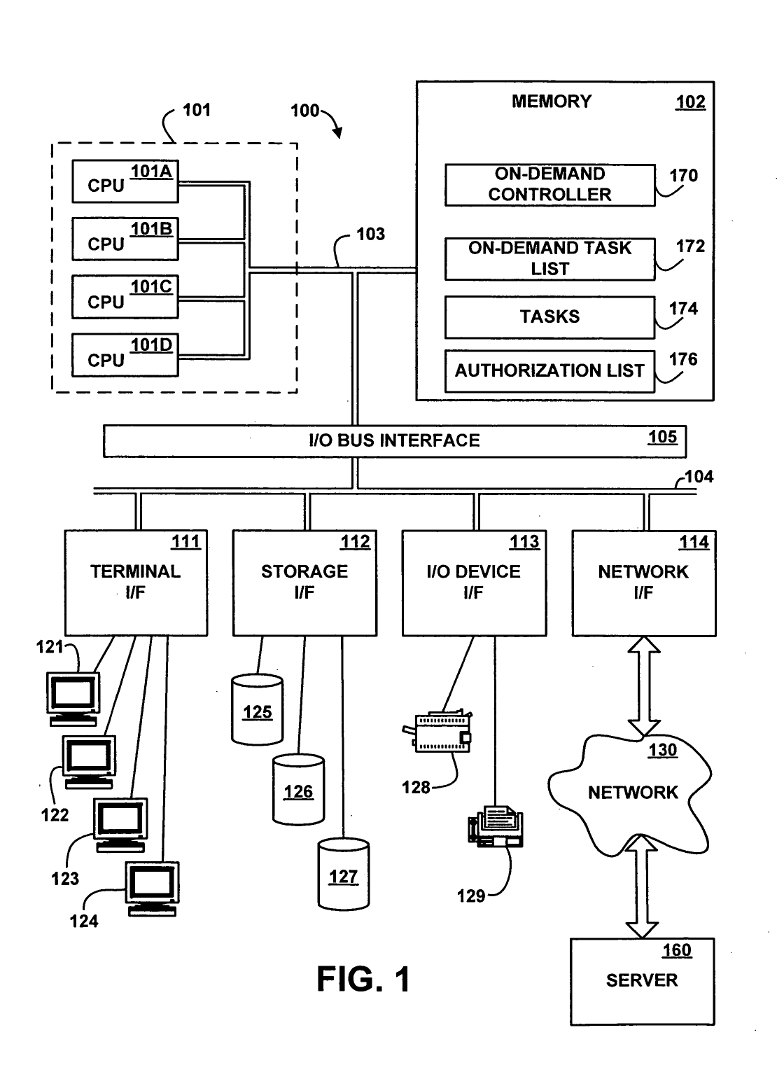

Referring to the Drawing, wherein like numbers denote like parts throughout the several views, FIG. 1 depicts a high-level block diagram representation of a computer system 100, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes an on-demand controller 170, an on-demand task list 172, tasks 174, and an authorization list 176. Although the on-demand controller 170, the on-demand task list 172, the tasks 174, and the authorization list 176 are illustrated as being contained within the memory 102 in the computer system 100, in other embodiments some or all of them may be on different computer systems (e.g., the server 160) and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the on-demand controller 170, the on-demand task list 172, the tasks 174, and the authorization list 176 are illustrated as residing in the memory 102, these elements are not necessarily all completely contained in the same storage device at the same time.

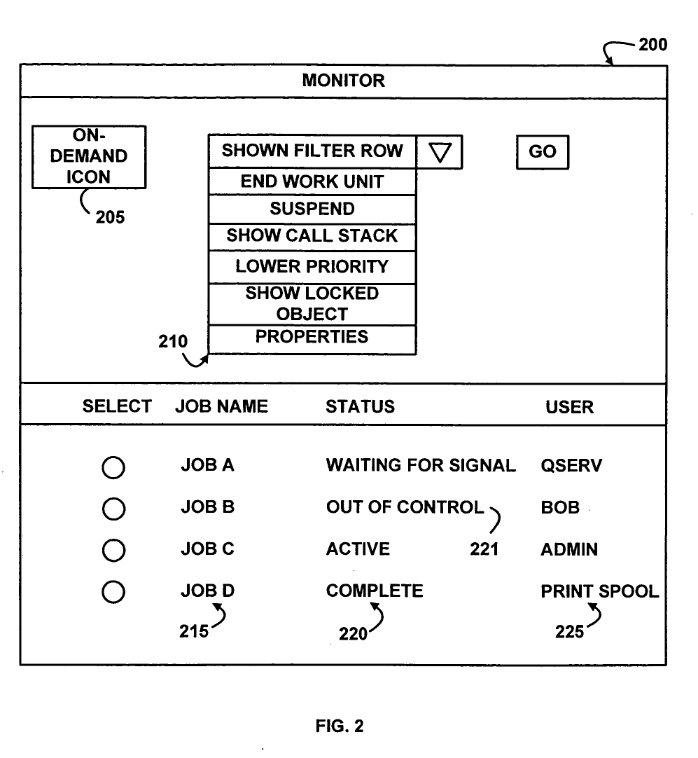

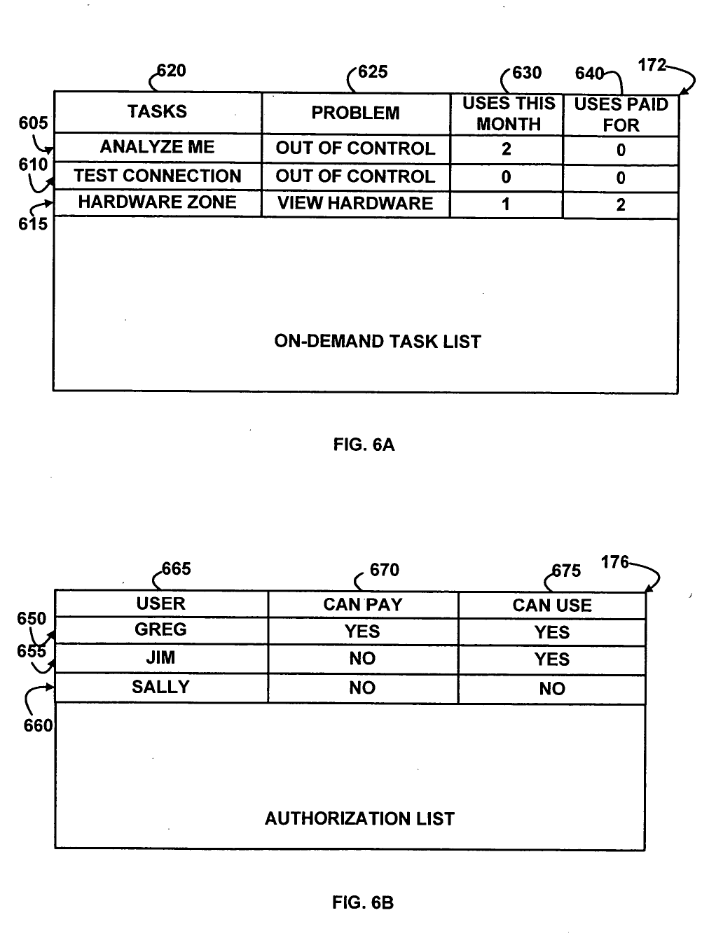

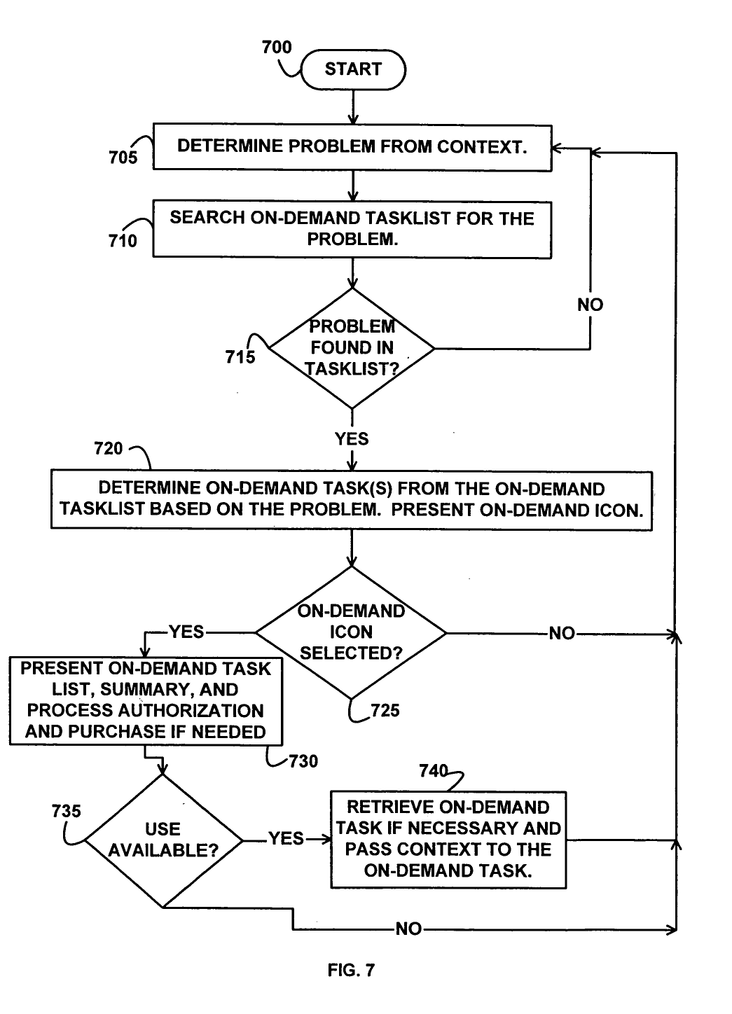

In an embodiment, the on-demand controller 170 includes instructions capable of executing on the processor 101 or statements capable of being interpreted by instructions executing on the processor 101 to operate the user interfaces as further described below with reference to FIGS. 2-5, to access the on-demand task list data structure 172 as further described below with reference to FIG. 6A, to access the authorization list data structure 176 as further described below with reference to FIG. 6B, and to perform the functions as further described below with reference to FIG. 7. In another embodiment, the on-demand controller 170 may be implemented in microcode. In yet another embodiment, the on-demand controller 170 may be implemented in hardware via logic gates and/or other appropriate hardware techniques, in lieu of or in addition to a processor-based system.

The on-demand task list 172 is a data structure used by the on-demand controller 170 to save information about the tasks 174. The tasks 174 provide functions that may be used on demand, as controlled by the on-demand controller 170. In another embodiment, the tasks 174 are downloaded from another computer, such as the server 160 via the network 130. The authorization list 176 is a data structure used by the on-demand controller 170 to save information regarding the authorization of users to use the on-demand tasks in the tasks 174 and to purchase uses of the on-demand tasks.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100 and the server 160. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a pictorial representation of an example user interface 200 that includes a problem, according to an embodiment of the invention. The user interface 200 includes a monitoring task that monitors the status of jobs in the computer system 100. But, in other embodiments any appropriate task may be used with any user interface elements and data. The user interface 200 includes an on-demand icon 205, available tasks 210, job names 215, detailed status 220 of the jobs, a problem 221, and users 225.

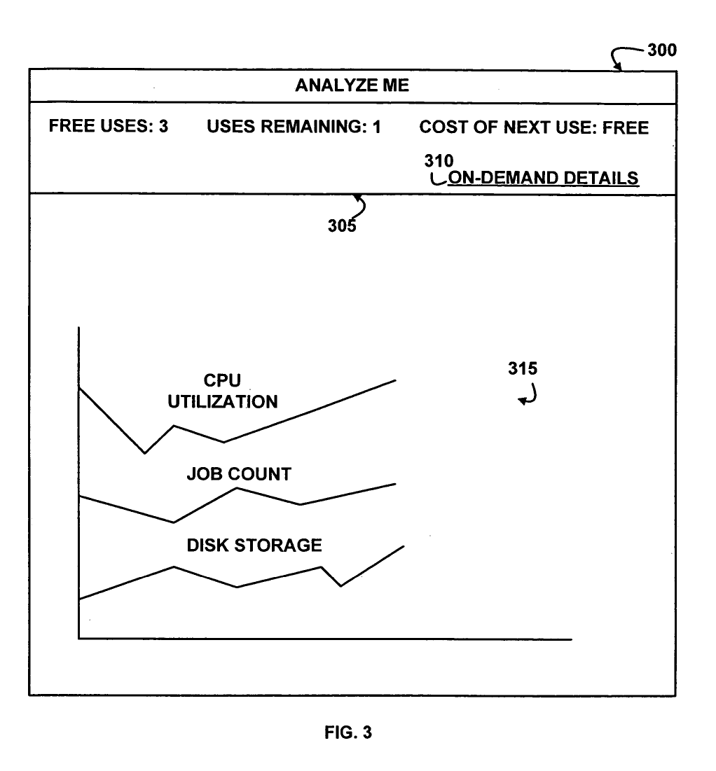

The on-demand icon 205 is displayed by the on-demand controller 170 to indicate that an additional function or task in the on-demand tasks 174 may be used or purchased on-demand to address the problem 221. When the on-demand icon 205 is selected, in response the on-demand controller 170 presents a list of on-demand tasks, which are available to address the problem 221. In response to the user selecting one of the available on-demand tasks, the on-demand controller 170 determines whether a use of the selected on-demand task is available, determines whether the selecting user is authorized to purchase additional uses of the on-demand task (in this example the “analyze me” task, as further described below with reference to FIG. 3), determines whether purchase of additional uses is within a budget, and processes the purchase of the additional uses if allowed. If the user is not allowed to purchase a use, then the user can only use pre-authorized uses. The on-demand controller 170 may also control access to each on-demand task, so that only authorized users can access that particular on-demand task, and authorized uses are not wasted. If the user has a use available, whether newly purchased or pre-existing, the on-demand controller 170 presents the corresponding user interface, e.g., the user interface of FIG. 3. The available tasks 210 include functions that are currently available for use through the user interface 200.

The job names 215 indicate applications that are being monitored via the user interface 200. The status 220 indicates the status of the jobs indicated by the respective job names 215. The problem 221 is a problem, condition, or status of one of the jobs 215 that may be potentially helped, investigated, or otherwise addressed by an additional function or task in the on-demand tasks 174, which may be selected by the on-demand icon 205. In another embodiment, the problem 221 may be any problem, condition, or status for which an additional function or task may be helpful.

Although the icon 205 is illustrated, in other embodiments any appropriate notification of the availability of an on-demand task relevant to the problem 221 may be used. For example, a voice prompt, fax, email, telephone call, pop-up window, sound, color, reverse video, highlighting, or any other appropriate notification may be used.

The users 225 are associated with the respective jobs 215. For example, the users 225 may be the originators of the respective jobs 215 or may have any other association with the jobs 215. All of the data in the job name 215, the status 220, and the user 225 together make up the context of the environment associated with the user interface 200. But, in other embodiments, the context may be any data associated with the problem 221. The on-demand controller 170 determines the problem 221 from the context.

FIG. 3 depicts a pictorial representation of an example user interface 300 for the “analyze me” on-demand task, according to an embodiment of the invention. The on-demand controller 170 displays the user interface 300 in response to the selection of the on-demand icon 205 (FIG. 2) after determining that the analyze me task is appropriate for the problem 221 (FIG. 2). In another embodiment, the on-demand controller 170 may display the user interface 300 in response to any appropriate command or stimulus. The user interface 300 includes an on-demand summary 305, an on-demand details icon 310, and data 315 presented by the “analyze me” on-demand task.

The on-demand summary 305 includes use information, such as the number of free uses of the on-demand task, the number of uses of the on-demand task that remain, and the cost of the next use. In various embodiments, the on-demand task may be available for free for a number of uses or a number of uses per a time period, such as a day, week, month, or any other time period.

In response to the selection of the on-demand details icon 310, the on-demand controller 170 displays help about the on-demand task and information regarding the per-use cost, plus any other optional information.

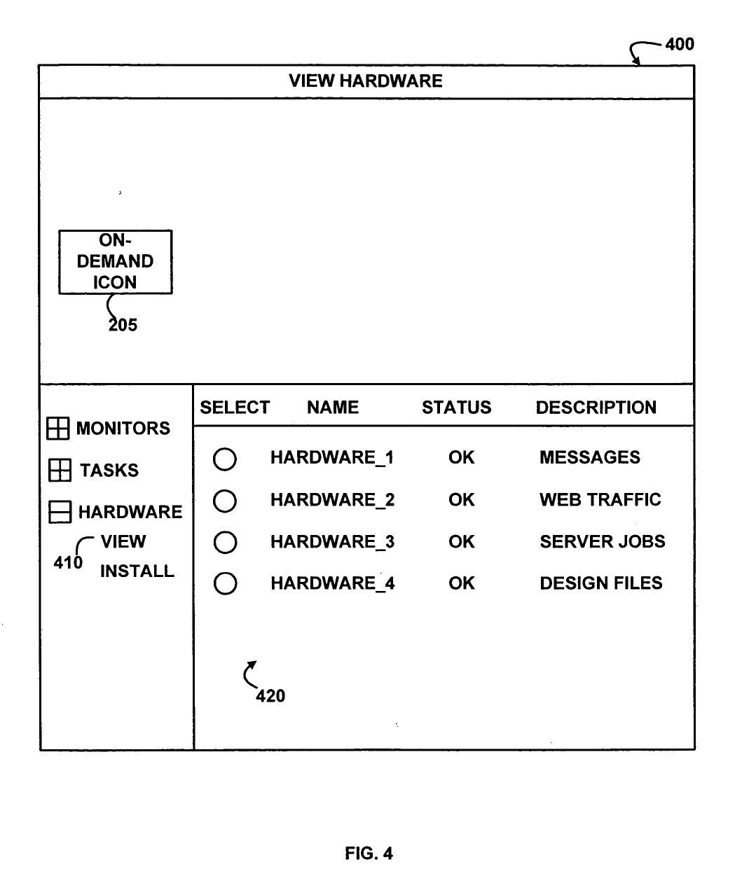

FIG. 4 depicts a pictorial representation of an example user interface 400 for a view hardware task, according to an embodiment of the invention. The user interface 400 includes the on-demand icon 205, the view hardware icon 410, and the view hardware data 420. In response to a selection of the view hardware icon 410, the view hardware function is invoked and displays the view hardware data 420. The on-demand controller 170 determines a problem, which in this case is the function represented by the view hardware icon 410, from the context, which is the user interface 400. The on-demand controller 170 determines that an on-demand task is available to address this problem, so in response the on-demand controller 170 displays the on-demand icon 205, indicating that an on-demand task is available to address the problem that exists in the context. When, as in this example, the problem is a function, the on-demand controller 170 determines an on-demand task that may be more helpful than the task the user is currently using, which is the view hardware task in this example.

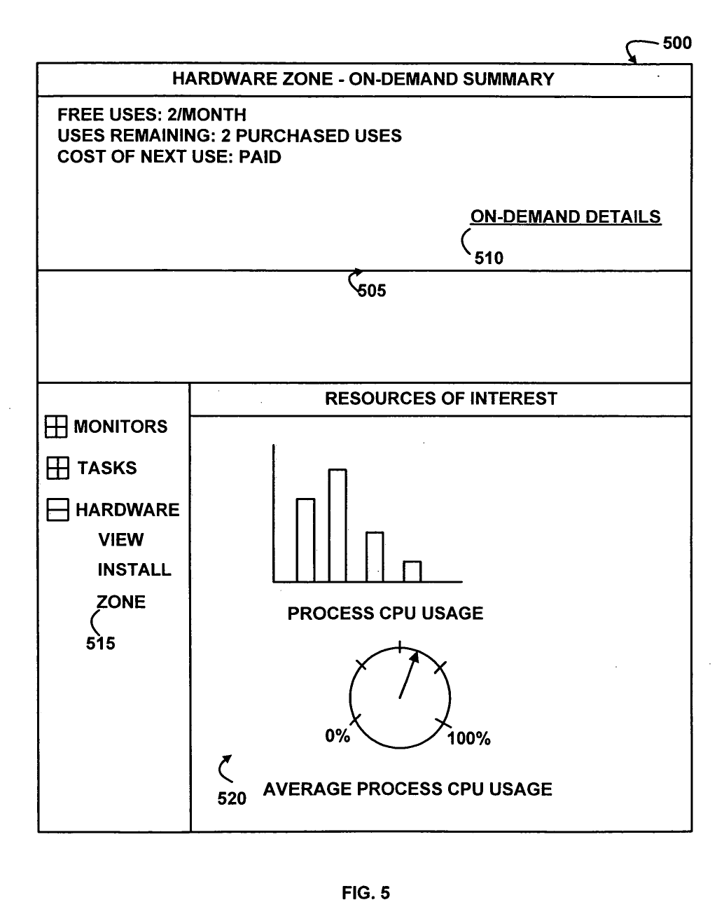

When the on-demand icon 205 is selected, in response the on-demand controller 170 presents a list of on-demand tasks, which are available to address the problem 410. In response to the user selecting one of the available on-demand tasks, the on-demand controller 170 determines whether a use of the selected on-demand task is available, determines whether the selecting user is authorized to purchase additional uses of the on-demand task (in this example the “hardware zone” task, as further described below with reference to FIG. 5), determines whether purchase of additional uses is within a budget, and processes the purchase of the additional uses if allowed. If the user is not allowed to purchase a use, then the user can only use pre-authorized uses. The on-demand controller 170 may also control access to each on-demand task, so that only authorized users can access that particular on-demand task, and authorized uses are not wasted. If the user has a use available, whether newly purchased or pre-existing, the on-demand controller 170 presents the corresponding user interface, e.g., the user interface of FIG. 5.

FIG. 5 depicts a pictorial representation of an example user interface 500 for an on-demand task, which in this example is the hardware zone task, according to an embodiment of the invention. The user interface 500 includes an on-demand summary 505, an on-demand details icon 510, a zone icon 515, and a display of data 520 from the “hardware zone” on-demand task.

The on-demand summary 505 includes use information, such as the number of free uses of the on-demand task, the number of uses of the on-demand task that remain, and the cost of the next use. In various embodiments, the on-demand task may be available for free for a number of uses or a number of uses per a time period, such as a day, week, month, or any other time period.

In response to the selection of the on-demand details icon 510, the on-demand controller 170 displays help about the on-demand task and information regarding the per-use cost, plus any other optional information.

The presence of the zone icon 515 indicates that the hardware zone on-demand task is now available for use. The display of data 520 is output from the hardware zone task. The on-demand hardware zone task uses the passed context to perform its analysis and display the data 520.

FIG. 6A depicts a block diagram of an example data structure for the on-demand task list 172, according to an embodiment of the invention. The on-demand task list 172 includes entries 605, 610, and 615, each of which includes a tasks field 620, a problem field 625, a uses field 630, and a uses paid for field 640. The tasks field 620 includes an identification of an available on-demand task in the tasks 174 (FIG. 1), which may be present in the computer system 100 or may need to be retrieved from a remote system, such as the server 160 (FIG. 1).

The problem field 625 includes a problem, condition, or function for which the respective task 620 may be helpful. The uses field 630 indicates the number of uses of the respective task 620 that are available. Although FIG. 6A illustrates that the uses 630 is expressed in terms of uses per month, in other embodiments the uses 630 may be expressed in uses per day, per week, per year, or per any other unit of time. In another embodiments, the uses field 630 may be expressed as an absolute number. The uses paid for field 640 indicates the number of uses of the respective task 620 that have been paid for.

“Out of control” is an example of a condition in the problem 625. “View hardware” is an example of a function in the problem 625. The data shown in the entries 605, 610, and 615 is exemplary only, and in other embodiments any appropriate data may be used.

FIG. 6B depicts a block diagram of an example data structure for an authorization list 176, according to an embodiment of the invention. The authorization list 176 includes entries 650, 655, and 660, each of which includes a user field 665, a can pay field 670, and a can use field 675. The user field 665 identifies a user. The can pay field 670 indicates whether the respective associated user identified in the user field 665 is authorized to purchase additional uses of an on-demand task. The can use field 675 indicates whether the respective associated user identified in the user field 665 is authorized to use an on-demand task. In various embodiments, the authorization list 176 may be global to all on-demand tasks or unique to a particular on-demand task with different entries or different authorization lists for different on-demand tasks.

FIG. 7 depicts a flowchart of example processing for the on-demand controller 170, according to an embodiment of the invention. Control begins at block 700. Control then continues to block 705 where the on-demand controller 170 determines the problem from the context. The problem may be a condition (as previously described above with reference to FIG. 2) or a function (as previously described above with reference to FIG. 4). Control then continues to block 710 where the on-demand controller 170 searches the on-demand task list 172 for the problem previously determined at block 705 in the problem field 625. Control then continues to block 715 where the on-demand controller 170 determines whether the problem was found in the problem field 625 in the on-demand task list 172.

If the determination at block 715 is true, then the problem was found in the on-demand task list 172, so control continues from block 715 to block 720 where the on-demand controller 170 determines the available on-demand task(s) 620 that are associated with the found problem in the problem field 625 of the on-demand task list 172. The on-demand controller 170 then presents the on-demand icon 205, indicating that at least one on-demand task is available that is relevant to the problem.

Control then continues to block 725 where the on-demand controller 170 determines whether the on-demand icon 205 is selected (or in other embodiments whether a command or other stimulus is issued). If the determination at block 725 is true, then the user has selected the on-demand icon 205, so control continues from block 725 to block 730 where the on-demand controller 170 presents an optional on-demand task list, presents the on-demand summary (e.g., the on-demand summary 305 in FIG. 3 or the on-demand summary 505 in FIG. 5), and processes a purchase of uses as needed. In an embodiment, the on-demand controller 170 provides the ability for a system administrator to allow or disallow users to purchase or use the on-demand tasks 174 via the authorization list 176 based on user authority, expertise, budget, or any other appropriate criteria.

Control then continues to block 735 where the on-demand controller 170 determines whether a use is available. If the determination at block 735 is true, then a use is available, so control continues to block 740 where the on-demand controller 170 retrieves the selected on-demand task and passes the context to the on-demand task. The on-demand task then begins execution using the context. Control then returns to block 705, as previously described above.

If the determination at block 735 is false, then a use is not available, so control returns from block 735 to block 705, as previously described above.

If the determination at block 725 is false, then the on-demand icon 215 is not selected, so control returns from block 725 to block 705, as previously described above.

If the determination at block 715 is false, then the problem was not found in the problem field 625 of the on-demand task list 172, so control returns from block 715 to block 705, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
determining a problem from a context;
finding an on-demand task associated with the problem; and
presenting a notification of the availability of the on-demand task.

2. The method of claim 1, further comprising:
passing the context to the on-demand task.

3. The method of claim 1, wherein the presenting the notification further comprises:
displaying an icon indicating that the on-demand task is available.

4. The method of claim 1, further comprising:
determining whether a use of the on-demand task is available.

5. An apparatus comprising:
means for determining a problem from a context;
means for finding an on-demand task associated with the problem; and
means for displaying an icon indicating that the on-demand task is available.

6. The apparatus of claim 5, further comprising:
means for passing the context to the on-demand task in response to a selection of the icon.

7. The apparatus of claim 5, wherein the problem comprises a condition.

8. The apparatus of claim 5, wherein the problem comprises a function.

9. A signal-bearing medium encoded with instructions, wherein the instructions when executed comprise:
determining a problem from a context;
finding an on-demand task associated with the problem;
displaying an icon indicating that the on-demand task is available; and
passing the context to the on-demand task in response to a selection of the icon.

10. The signal-bearing medium of claim 9, further comprising:
determining whether a user is authorized to use the on-demand task.

11. The signal-bearing medium of claim 9, further comprising:
determining whether a user is authorized to purchase a use of the on-demand task.

12. The signal-bearing medium of claim 9, further comprising:
processing a purchase of a use of the on-demand task.

13. A computer system comprising:
a processor; and
memory encoded with instructions, wherein the instructions when executed on the processor comprise:
determining a problem from a context,
finding an on-demand task associated with the problem,
displaying an icon indicating that the on-demand task is available,
passing the context to the on-demand task in response to a selection of the icon, and
determining whether a use of the on-demand task is available.

14. The computer system of claim 13, wherein the instructions further comprise:
processing a purchase of the use of the on-demand task.

15. The computer system of claim 13, wherein the problem comprises a condition

16. The computer system of claim 13, wherein the problem comprises a function.

17. A method of configuring a computer to perform the method comprising:
configuring the computer to determine a problem from a context;
configuring the computer to find an on-demand task associated with the problem; and
configuring the computer to present a notification of the availability of the on-demand task.

18. The method of claim 17, further comprising:
configuring the computer to pass the context to the on-demand task.

19. The method of claim 17, wherein the configuring the computer to present the notification further comprises:
configuring the computer to display an icon indicating that the on-demand task is available.

20. The method of claim 17, further comprising:
configuring the computer to determine whether a use of the on-demand task is available.
